(19) United States
(12) Patent Application Publication
(10) Pub. No.: US 2026/0118818 A1
(43) Pub. Date: Apr. 30, 2026

(54) IMAGE FORMING APPARATUS

(71) Applicant: KYOCERA Document Solutions Inc., Osaka (JP)

(72) Inventors: Yuzo HARADA, Osaka (JP); Kazuhisa HIRAHARA, Osaka (JP)

(73) Assignee: KYOCERA Document Solutions Inc., Osaka (JP)

(21) Appl. No.: 19/362,077

(22) Filed: Oct. 17, 2025

(30) Foreign Application Priority Data
Oct. 30, 2024 (JP) 2024-190434

(51) Int. Cl. G03G 21/16; G03G 15/00; G03G 15/08

(52) U.S. Cl. CPC G03G 21/1647; G03G 15/0808; G03G 15/80; G03G 21/1619; G03G 2221/1654

(57) ABSTRACT

An image forming apparatus includes a photosensitive drum, a development unit, a unit frame that, by moving in one direction, moves a development roller in a direction toward the photosensitive drum and, by moving in the other direction, moves the development roller in a direction away from the photosensitive drum, a unit-side contact, and a body-side contact. Moving the unit frame in one direction brings the unit-side contact and the body-side contact into contact with each other and moving the unit frame in the other direction releases the unit-side contact and the body-side contact from contact with each other.

### INCORPORATION BY REFERENCE

This application is based on and claims the benefit of priority from Japanese Patent Application No. 2024-190434 filed on October 30, 2024, the contents of which are hereby incorporated by reference.

### BACKGROUND

The present disclosure relates to an image forming apparatus.

An image forming apparatus includes a development unit that develops an electrostatic latent image into a toner image. For example, the development unit is removably mounted in the body of the image forming apparatus. Thus, the body of the image forming apparatus is provided with a unit frame on which the development unit is mounted. The development unit is removably mounted on the unit frame.

Typically, to electrically connect together the body of the image forming apparatus and the development unit, a cable is used. For example, the unit frame on which the development unit is mounted and the body of the image forming apparatus are electrically connected with a cable. In a case where a cable is used to electrically connect the body of the image forming apparatus and the development unit, because the cable is difficult to keep in position, it is difficult to replace a wiring of electrically connecting together the body of the image forming apparatus and the development unit with an automated production using a robot and the like.

### SUMMARY

According to one aspect of the present disclosure, an image forming apparatus includes a photosensitive drum, a development unit, a unit frame, a unit-side contact, and a body-side contact. The development unit is disposed opposite the photosensitive drum and has a development roller rotatably supported. The development unit feeds toner from the development roller to an electrostatic latent image on the photosensitive drum to develop it into a toner image. On the unit frame, the development unit is removably mounted. The unit frame is movable about an axis parallel to the rotation axis of the development roller. The unit frame, by moving in one direction about the axis, moves the development roller in a direction toward the photosensitive drum and, by moving in the other direction about the axis, moves the development roller in a direction away from the photosensitive drum. The unit-side contact is fitted to the unit frame and is electrically connected to the development unit mounted on the unit frame. The body-side contact is disposed at a position where it can make contact with the unit-side contact. From a state where the unit-side contact and the body-side contact are out of contact with each other, moving the unit frame in one direction brings the unit-side contact and the body-side contact into contact with each other and, from a state where the unit-side contact and the body-side contact are in contact with each other, moving the unit frame in the other direction releases the unit-side contact and the body-side contact from contact with each other.

### BRIEF DESCRIPTION OF THE DRAWINGS

FIG. 1 is a schematic diagram of an image forming apparatus according to an embodiment.

FIG. 2 is a schematic diagram of an image forming portion according to the embodiment.

FIG. 3 is a perspective view of a development unit according to the embodiment.

FIG. 4 is a perspective view of a unit frame according to the embodiment and its surroundings (without the development unit).

FIG. 5 is a schematic perspective view (as seen from above) of the unit frame according to the embodiment.

FIG. 6 is a schematic perspective view (as seen from below) of the unit frame according to the embodiment.

FIG. 7 is a schematic diagram of the unit frame in a regular position according to the embodiment.

FIG. 8 is a schematic diagram of the unit frame in a mounting/removing position according to the embodiment.

FIG. 9 is a schematic diagram showing a state where a pressed portion of the unit frame according to the embodiment is pressed.

FIG. 10 is a schematic diagram showing a state where the pressed portion of the unit frame according to the embodiment is not pressed.

FIG. 11 is a perspective view of a unit back portion of the unit frame according to the embodiment and its surroundings.

FIG. 12 is a perspective view of a unit-side contact according to the embodiment.

### DETAILED DESCRIPTION

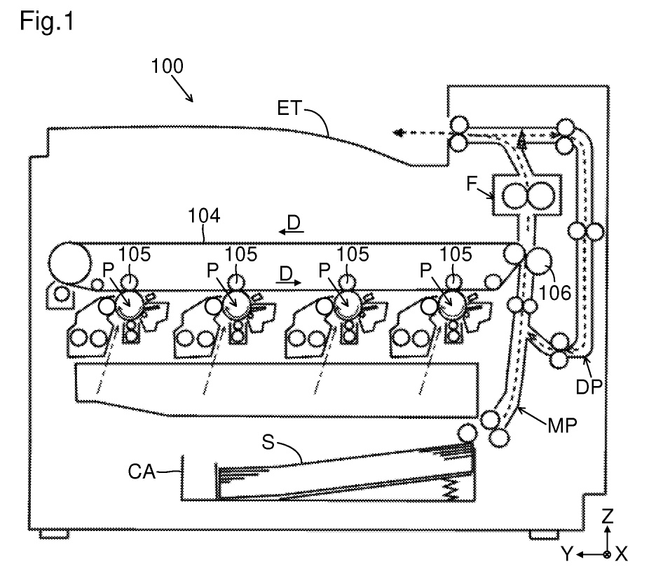

With reference to FIGS. 1 to 12, an image forming apparatus 100 according to an embodiment will be described below with a color laser printer of a tandem type taken as an example. What is disclosed herein is applicable not only to color laser printers but also to monochrome printers, multifunctional peripherals, and the like.

Note that, the diagrams referred to in the description below show, for ease of understanding, an XYZ-orthogonal coordinate system. Direction Z is the vertical direction and aligns with the top-bottom direction of the image forming apparatus 100. The flat surface on which the image forming apparatus 100 is installed aligns with the surface perpendicular to direction Z. The direction in which the arrow of the Z-axis points is “upward” and the opposite direction is “downward.”

Direction X is one horizontal direction and direction Y is another horizontal direction. For example, direction X corresponds to the front-rear direction of the image forming apparatus 100. Direction Y corresponds to the left-right direction of the image forming apparatus 100.

### Overall Configuration of Image Forming Apparatus

As shown in FIG. 1, the image forming apparatus 100 according to the embodiment includes a main conveyance passage MP. The image forming apparatus 100 also includes a sheet cassette CA. The sheet cassette CA is removably mounted in the body of the image forming apparatus 100. The sheet cassette CA stores sheets S. The main conveyance passage MP leads from the sheet cassette CA via a transferring position and a fixing position in this order to a discharge tray ET.

In a print job, a sheet S in the sheet cassette CA is fed to the main conveyance passage MP. Then, the sheet S is conveyed along the main conveyance passage MP and an image is printed on the sheet S being conveyed. In other words, a transferring process in which a toner image is transferred to the sheet S being conveyed is performed at the transferring position. At the fixing position, a fixing process in which the toner image is fixed to the sheet S is performed.

The image forming apparatus 100 includes image forming portions P for four colors, namely cyan, magenta, yellow, and black. Each of the image forming portions P forms a toner image of the corresponding color. With focus on one image forming portion P, its configuration will be described below. The image forming portions P have basically the same configuration. For the configuration of the other image forming portions P, no overlapping description will be repeated and reference is to be made to the description below.

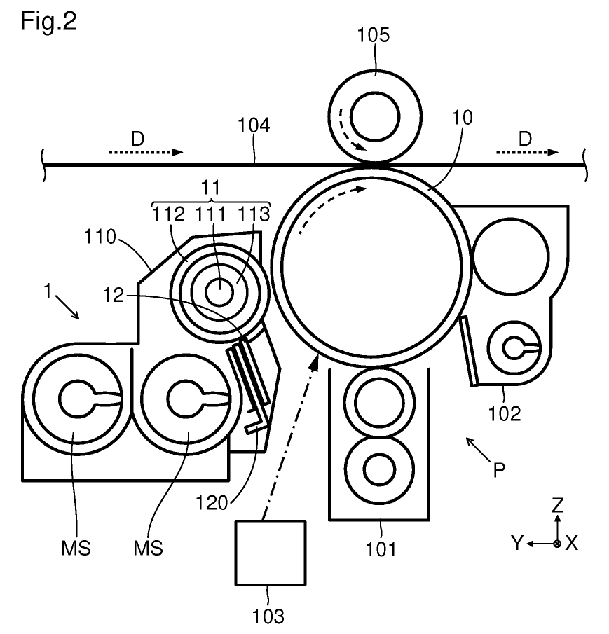

The image forming portion P has a configuration as shown in FIG. 2. The image forming portion P includes a development unit 1. The image forming portion P also includes a photosensitive drum 10. The photosensitive drum 10 is, together with a charging device 101 and a cleaning device 102, built into a unit. Note that the image forming portion P includes an exposure device 103. One exposure device 103 is provided and is shared by the image forming portions P.

When an image is formed by the image forming portion P, the photosensitive drum 10 rotates. The charging device 101 electrostatically charges the outer circumferential surface of the photosensitive drum 10. The exposure device 103 shines light to the outer circumferential surface of the photosensitive drum 10 to form an electrostatic latent image on the outer circumferential surface of the photosensitive drum 10. Then, the development unit 1 feeds toner to the electrostatic latent image on the outer circumferential surface of the photosensitive drum 10 to develop the electrostatic latent image into a toner image. The cleaning device 102 removes the residual toner on the outer circumferential surface of the photosensitive drum 10.

With reference back to FIG. 1, the image forming apparatus 100 includes an intermediate transfer belt 104. The intermediate transfer belt 104 is an endless belt. The intermediate transfer belt 104 is in contact with the outer circumferential surface of the photosensitive drum 10 and is, in that state, driven (to rotate) in the direction indicated by arrow D.

The image forming apparatus 100 includes a plurality of primary transfer rollers 105. The primary transfer rollers 105 are assigned each to one of the different colors, namely cyan, magenta, yellow, and black. The primary transfer rollers 105 are disposed on the inner circumference side of the intermediate transfer belt 104. The primary transfer rollers 105 are disposed across the intermediate transfer belt 104 opposite the photosensitive drums 10 that carries the toner images of the corresponding colors.

The image forming apparatus 100 further includes one secondary transfer roller 106. The secondary transfer roller 106 is in pressed contact with the outer circumferential surface of the intermediate transfer belt 104 at the transferring position. The secondary transfer roller 106 forms a transfer nip with the intermediate transfer belt 104. The main conveyance passage MP runs through the transfer nip.

In a print job, a sheet S is conveyed toward the transferring position (i.e., the transfer nip). The sheet S being conveyed passes through the transfer nip.

The intermediate transfer belt 104 has the toner images primarily transferred to it from the photosensitive drums 10. The intermediate transfer belt 104 rotates while carrying the toner images on its outer circumferential surface. While the sheet S is passing through the transfer nip, the sheet S makes contact with the outer circumferential surface of the intermediate transfer belt 104. Thus the toner images are secondarily transferred to the sheet S passing through the transfer nip.

Note that different rotary members such as the photosensitive drum 10 in the image forming portion P rotate about an axis extending along direction X. Likewise, the primary and secondary transfer rollers 105 and 106 rotate about an axis extending along direction X.

The image forming apparatus 100 includes a fixing portion F. The fixing portion F includes a heating roller and a pressing roller. The heating roller incorporates a heater. The pressing roller is in pressed contact with the heating roller. The heating and pressing rollers are in pressed contact with each other to form a fixing nip at the fixing position.

In the print job, the sheet S having the toner images transferred to it passes through the fixing nip. That is, the sheet S is nipped in the fixing nip between the heating and pressing rollers. The fixing portion F heats the sheet S passing through the fixing nip. In the fixing nip, the sheet S is pressed. The fixing portion F, by heating and pressing the sheet S having the toner images transferred to it, fixes the toner images to the sheet S. After the fixing process, the sheet S is discharged onto the discharge tray ET.

The image forming apparatus 100 includes a conveyance portion, to which no reference sign is assigned. The conveyance portion includes a pair of conveyance rollers. The pair of conveyance rollers includes a pair of rollers. The pair of rollers has a conveyance nip between the rollers. The pair of conveyance rollers, by rotating, conveys the sheet S entered into the conveyance nip. The conveyance portion conveys the sheet S along the main conveyance passage MP. The conveyance portion conveys the sheet S also along a duplex printing conveyance passage DP, which will be described later.

The image forming apparatus 100 can perform, as a print job, not only a simplex printing job in which the toner images are printed only on one side of the sheet S but also a duplex printing job in which the toner images are printed on both sides of the sheet S. For the duplex printing job, the image forming apparatus 100 includes a duplex printing conveyance passage DP.

The duplex printing conveyance passage DP branches off the main conveyance passage MP at a branching position along it downstream of the fixing position in the sheet conveyance direction. Then, the duplex printing conveyance passage DP joins the main conveyance passage MP at a joining position along it upstream of the transfer position in the sheet conveyance direction.

If the job being performed is a simplex printing, the sheet S passes through the transfer nip only once and a transferring process is performed once on the sheet S passing through the transfer nip. Then, when the first-time transferring is complete, the sheet S is discharged as it is onto the discharge tray ET.

If the job being performed is a duplex print job, the sheet S passes through the transfer nip twice so that a transferring process is performed once on each of the front and back sides of the sheet S. Specifically, when the sheet S passes through the transfer nip for the first time, a transferring process is performed on one side of the sheet S. When the first-time transferring process is complete, after the trailing edge of the sheet S has passed through the branching position, before the sheet S is completely discharged onto the discharge tray ET, the sheet S is switched back. Thus, the sheet S is, starting with its trailing edge, pulled into the duplex printing conveyance passage DP.

After that, the sheet S is conveyed along the duplex printing conveyance passage DP. The sheet S in the duplex printing conveyance passage DP is then returned from the joining position to the main conveyance passage MP. The sheet S brought back to the main conveyance passage MP is conveyed along it and passes through the transfer nip once again. At that time, the front and back sides of the sheet S are reversed as compared with when it passed through the transfer nip for the first time. Thus, when the sheet S passes through the transfer nip for the second time, a transferring process is performed on the other side of the sheet S, that is, the side opposite from the one side.

### Configuration of Development Device

With focus on one development unit 1, its configuration will be described below. The development units 1 have basically the same configuration. Thus, for the configuration of the other development units 1, no overlapping description will be repeated and reference is to be made to the description below.

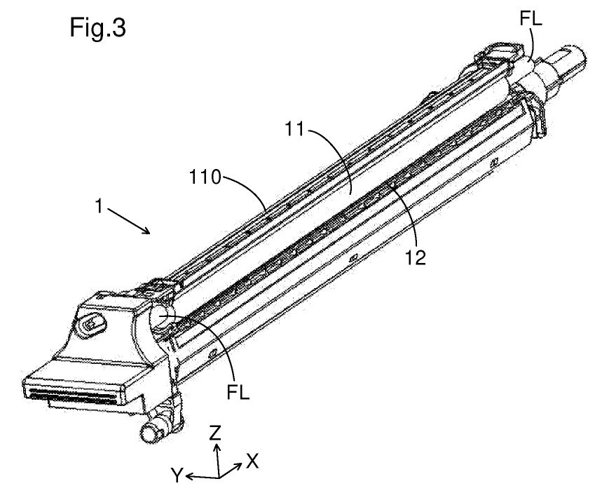

The development unit 1 extends along direction X as shown in FIG. 3. The development unit 1 includes a developer container 110. The longitudinal direction of the developer container 110 aligns with direction X. The developer container 110 contains developer containing toner. The developer stored in the developer container 110 is, for example, magnetic one-component developer containing magnetic toner. The toner in the developer container 110 is used for development.

As shown in FIG. 2, the development unit 1 includes a development roller 11. The development roller 11 is disposed inside the developer container 110. The development roller 11 is supported so as to be rotatable about an axis extending along direction X.

Of the development roller 11, the outer circumferential surface is exposed from inside to outside the developer container 110. Specifically, the developer container 110 has an opening (no reference sign assigned) at a position opposite the photosensitive drum 10. Through this opening, the outer circumferential surface of the development roller 11 is exposed outside. Thus, the outer circumferential surface of the development roller 11 and the outer circumferential surface of the photosensitive drum 10 face each other. The development roller 11 carries toner on its outer circumferential surface and feeds the toner to an electrostatic latent image on the outer circumferential surface of the photosensitive drum 10.

The development roller 11 has a shaft 111, a sleeve 112, and a magnet 113. The shaft 111 extends along direction X. The sleeve 112 is a cylindrical member extending along direction X. The shaft 111 is inserted in the sleeve 112.

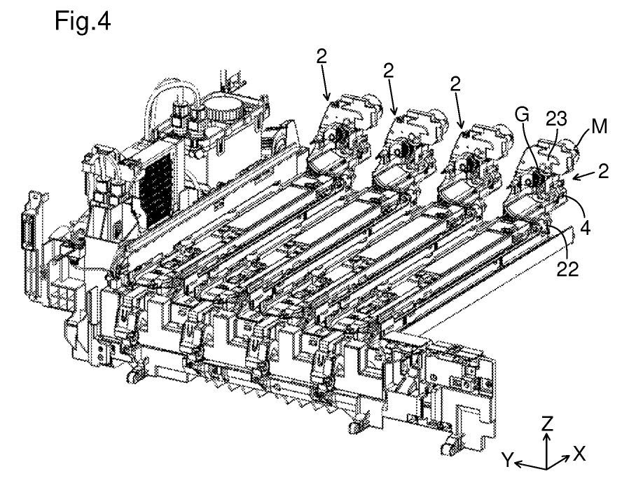

The sleeve 112 is supported so as to be rotatable about the axis of the shaft 111. For example, to each of the opposite ends of the shaft 111 along the axial direction, a flange FL (see FIG. 3) is disposed that is rotatable relative to the shaft 111. The flange FL rotates by receiving power transmitted from a motor M (see FIG. 4). The sleeve 112 is fixed to the flange FL and rotates together with the flange FL.

The sleeve 112 has an outer circumferential surface that faces the photosensitive drum 10. That is, the outer circumferential surface of the sleeve 112 is the outer circumferential surface of the development roller 11. On the outer circumferential surface of the sleeve 112, toner is carried and that toner is fed to an electrostatic latent image on the outer circumferential surface of the photosensitive drum 10.

The magnet 113 is disposed inside the sleeve 112. The magnet 113 is fixed on the outer circumferential surface of the shaft 111 and extends along the axis of the shaft 111. The magnet 113 has a plurality of magnetic poles along the circumferential direction of the shaft 111. With the magnetic force of the magnet 113, the outer circumferential surface of the development roller 11 (that is, the outer circumferential surface of the sleeve 112) carries toner to form a magnetic brush on the outer circumferential surface of the development roller 11.

The development unit 1 also includes a regulation blade 12 made of metal. The regulation blade 12 is held by a blade holder 120 made of metal. The blade holder 120 is fitted to the developer container 110, so that the regulation blade 12 is disposed upstream, in the rotation direction of the development roller 11, of the region where the development roller 11 faces the photosensitive drum 10.

The regulation blade 12 is disposed with a tip part of it close to the outer circumferential surface of the development roller 11 (that is, the outer circumferential surface of the sleeve 112). The tip part of the regulation blade 12 is disposed opposite the outer circumferential surface of the development roller 11 across a predetermined interval.

The development unit 1 includes two stirring screws MS. The stirring screws MS are disposed inside the developer container 110. The stirring screws MS are supported so as to be rotatable about an axis extending along direction X.

The stirring screws MS have a structure in which a blade is spirally wound around a rotation shaft. By rotating, the stirring screws MS convey, while stirring, developer along direction X. The stirring screws MS convey developer in opposite directions to each other.

The developer in the development unit 1 is electrostatically charged by being stirred and is carried on the outer circumferential surface of the development roller 11 to form a magnetic brush. The magnetic brush on the outer circumferential surface of the development roller 11 passes between the development roller 11 and the regulation blade 12 and is regulated by the regulation blade 12 to have a uniform thickness.

Then, as the development roller 11 rotates, the magnetic brush with a predetermined thickness is conveyed to the region where the development roller 11 faces the photosensitive drum 10. To the development roller 11, a development voltage is applied. This produces a potential difference between the development roller 11 and the photosensitive drum 10 to feed the toner in the magnetic brush to the photosensitive drum 10.

### Support Frame in Development Unit

As shown in FIG. 4, the image forming apparatus 100 includes a unit frame 2. The unit frame 2 is installed in the body of the image forming apparatus 100. The unit frame 2 is assigned one to each of the development units 1. The unit frames 2 support the corresponding development units 1. The development units 1 are removably mounted on the corresponding unit frames 2. That is, the development units 1 are removable from the body of the image forming apparatus 100.

With focus on one unit frame 2, its configuration will be described in detail below. The unit frames 2 have the same configuration. Thus, for the configuration of the other unit frames 2, no overlapping description will be repeated and reference is to be made to the description below.

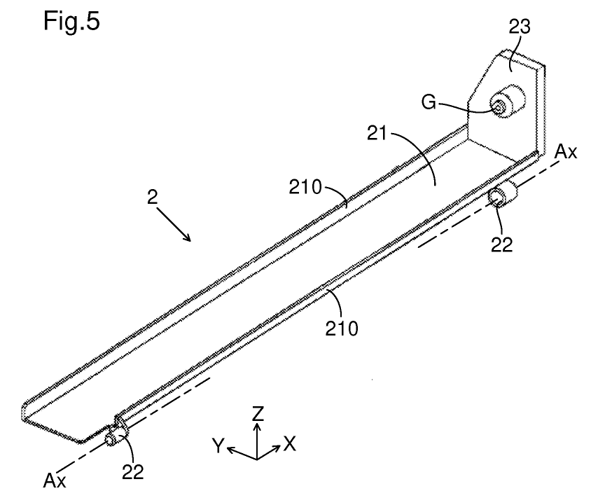

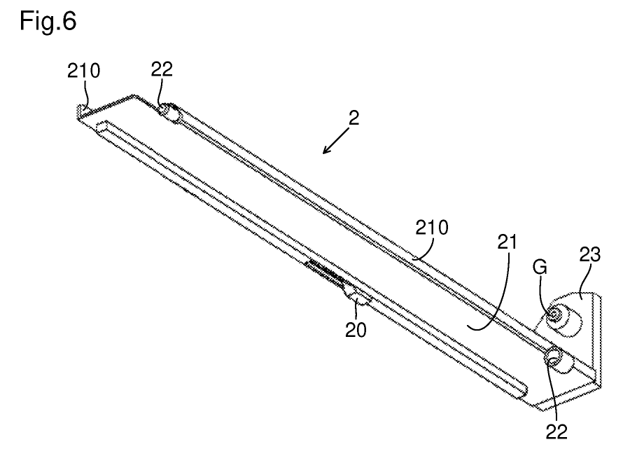

The unit frame 2 has a configuration as shown in FIGS. 5 and 6. Note that FIGS. 5 and 6 show the unit frame 2 only schematically and do not necessarily reflect actual dimensions and shapes.

The unit frame 2 is supported so as to be movable about an axis Ax that is parallel to the rotation axis of the development roller 11. Note that direction X coincides with the axial direction of the axis Ax (i.e., the axial direction of the rotation axis of the development roller 11).

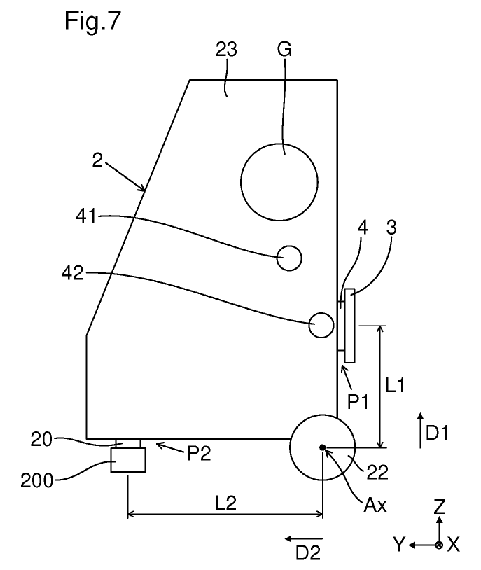

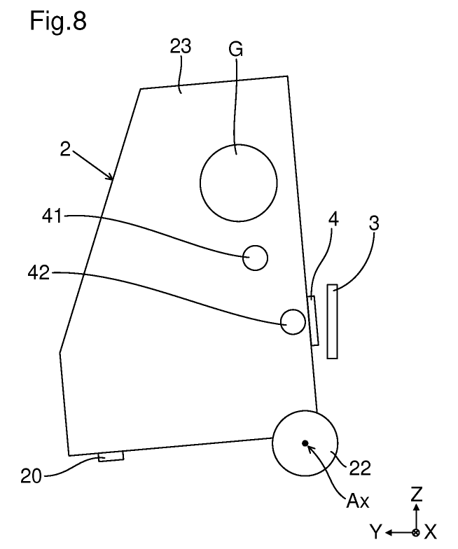

The unit frame 2 is movable about the axis Ax in one direction and in the other direction that is opposite to that direction. In other words, the development unit 1 is movable about the axis Ax in one and the other directions. Moving the development unit 1 about the axis Ax permits moving the development roller 11 close to the photosensitive drum 10 and moving the development roller 11 away from the photosensitive drum 10. FIG. 7 shows the unit frame 2 in a position where the development roller 11 is close to the photosensitive drum 10. FIG. 8 shows the unit frame 2 in a position where the development roller 11 is away from the photosensitive drum 10.

When the development unit 1 is mounted on the unit frame 2, the unit frame 2 is held in a mounting/removing position (see FIG. 8). From that state, mounting the development unit 1 on the unit frame 2 and moving the unit frame 2 in one direction about the axis Ax results in the unit frame 2 reaching a regular position (see FIG. 7). In this way, the development roller 11 is arranged opposite the photosensitive drum 10. That is, a state ready for a print job is brought about.

On the other hand, moving the unit frame 2 from the regular position in the other direction about the axis Ax results in the unit frame 2 reaching the mounting/removing position (see FIG. 8). This brings the development roller 11 away from the photosensitive drum 10. Holding the unit frame 2 in the mounting/removing position permits the development unit 1 to be removed from the unit frame 2.

The unit frame 2 has a frame bottom portion 21. The frame bottom portion 21 is in the form of a plate, of which the plate thickness direction aligns with direction Z. The frame bottom portion 21 is, as seen from direction Z, substantially in a rectangular shape, of which the longitudinal direction aligns with direction X and of which the lateral direction aligns with direction Y. The development unit 1 is disposed on the frame bottom portion 21. Note that each of opposite end parts of the frame bottom portion 21 along direction Y is provided with a frame wall portion 210 standing upright. The pair of frame wall portions 210 prevents displacement of the development unit 1 on the frame bottom portion 21 along direction Y.

The unit frame 2 also has a pair of support portions 22. The pair of support portions 22 is provided on one end part (right end part) of the frame bottom portion 21 along direction Y. One support portion 22 is disposed at one side (front side) of the frame bottom portion 21 along direction X and the other support portion 22 is disposed at the other side (rear side) of the frame bottom portion 21 along direction X. One support portion 22 is a round columnar member of which the central axis coincides with the axis Ax. The other support portion 22 is a cylindrical member of which the central axis coincides with the axis Ax.

The body of the image forming apparatus 100 is provided with, though not shown, a fitting hole in a circular shape of which the central axis coincides with the axis Ax, and a fit shaft in a columnar shape of which the central axis coincides with the axis Ax. One support portion 22 (in a round columnar shape) fits in the fitting hole in the body and the other support portion 22 (in a cylindrical shape) fits around the fit shaft of the body. In this way, the unit frame 2 is supported so as to be movable about the axis Ax.

The unit frame 2 has a frame back portion 23. The frame back portion 23 holds a drive system such as a gear G and a motor M (see FIG. 4). In a state where the development unit 1 is mounted on the unit frame 2, that is, in a state where the development unit 1 is disposed on the frame bottom portion 21, a rotary member in the development unit 1, such as the development roller 11, is connected to the motor M via the gear G.

Here, the unit frame 2 has a pressed portion 20 on the frame bottom portion 21. The pressed portion 20 projects downward from the frame bottom portion 21. The pressed portion 20 is disposed, on the frame bottom portion 21, at the opposite side, along direction Y, from the side at which the pair of support portions 22 is disposed. While the pair of support portions 22 is disposed at the right side, the pressed portion 20 is disposed at the left side.

The body of the image forming apparatus 100 is provided with, though not shown, a slider that is slidable along direction X. The slider is disposed below the frame bottom portion 21.

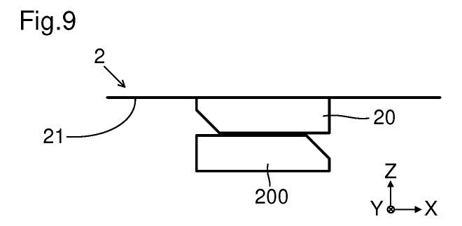

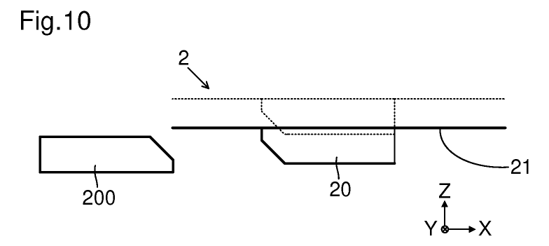

The slider has a pressing portion 200 (see FIGS. 9 and 10) projecting upward. The pressed portion 20 is disposed above the movement path of the pressing portion 200 along direction X. Thus, moving the slider along direction X permits the pressed portion 20 to be pressed upward by the pressing portion 200 or to be released from its pressure.

FIG. 9 schematically shows a state where the pressed portion 20 is pressed upward by the pressing portion 200. FIG. 10 shows a state where the pressed portion 20 is free from the upward pressing by the pressing portion 200. From the state shown in FIG. 9, moving the slider toward one side (front side) along direction X achieves the state shown in FIG. 10. In FIG. 10, broken lines indicate the pressed portion 20 pressed by the pressing portion 200.

When the pressing portion 200 is not pressing the pressed portion 20, as seen from direction X, a left end part of the frame bottom portion 21 is located lower than a right end part of it (see FIG. 8). Thus, the development roller 11 is held away from the photosensitive drum 10. That is, the unit frame 2 is held in the mounting/removing position.

From the state where the unit frame 2 is held in the mounting/removing position, moving the slider along direction X to press the pressed portion 20 upward with the pressing portion 200 results in the left end part of the frame bottom portion 21 moving upward as seen from direction X, so that the left and right ends of the frame bottom portion 21 are substantially at the same position along the top-bottom direction (see FIG. 7). Thus, the development roller 11 is disposed opposite the photosensitive drum 10. That is, the unit frame 2 reaches the regular position.

Note that the slider having the pressing portion 200 moves reciprocatively along direction X when so operated by the user of the image forming apparatus 100. That is, with user operation, the slider moves along direction X so that the pressed portion 20 is pressed upward by the pressing portion 200 or that the pressed portion 20 is released from its pressure.

For example, though not shown, the development unit 1 and its surroundings are covered with a front cover. The front cover is pivotable (openable/closable) about an axis extending along direction Y. Opening the front cover exposes the development unit 1, so that the development unit 1 can be mounted or removed along direction X.

The slider having the pressing portion 200 is coupled to the front cover via a linking member (not shown). Thus, when the front cover is opened, the slider is pulled toward one side (front side) along direction X and the pressing portion 200 moves toward one side along direction X. On the other hand, the front cover is closed, the slider is pushed back toward the other side (rear side) along direction X and the pressing portion 200 moves toward the other side along direction X.

With the front cover opened, the pressing portion 200 is held at a position where it is not in contact with the pressed portion 20 (see FIG. 10). That is, the pressing portion 200 does not press the pressed portion 20 upward. This holds the unit frame 2 in the mounting/removing position.

From the state where the front cover is open, as the front cover is closed, the pressing portion 200 approaches the pressed portion 20. Then, when the front cover is completely closed, the pressed portion 20 is on the pressing portion 200 (see FIG. 9). That is, the pressed portion 20 is pressed upward by the pressing portion 200. This brings the unit frame 2 to the regular position. Keeping this state without opening the front cover holds the unit frame 2 in the regular position.

From the state where the front cover is closed, as the front cover is opened, the pressing portion 200 moves away from the pressed portion 20, so that the pressed portion 20 is released from the upward pressure of the pressing portion 200 (see FIG. 10). The unit frame 2 reaches the mounting/removing position. Subsequently, keeping the front cover open holds the unit frame 2 in the mounting/removing position.

### Body-Side Contact and Unit-Side Contact

The image forming apparatus 100 includes a body-side contact 3 (see FIGS. 7 and 8). The body-side contact 3 is provided on the body of the image forming apparatus 100 and is connected to a circuit board (not shown). The circuit board controls the supply of electric power to the development unit 1 and the like. The body-side contact 3 is, for example, a wire spring made of a metal wire material.

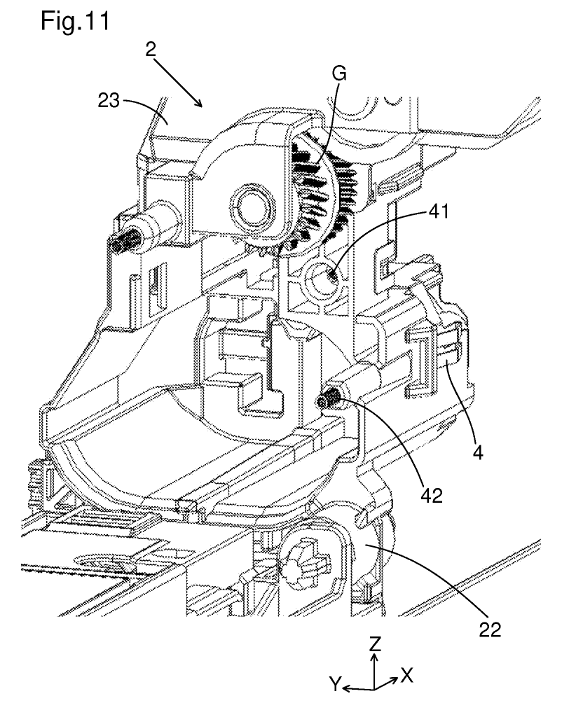

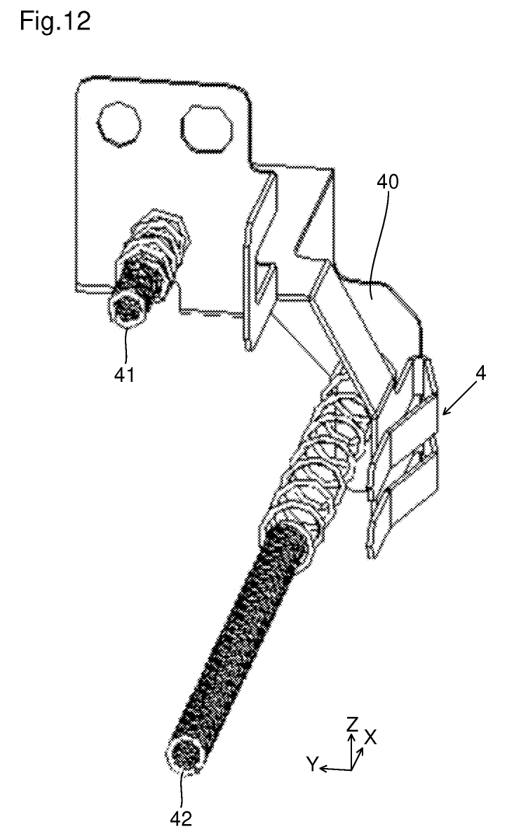

As shown in FIGS. 11 and 12, the image forming apparats 100 includes a unit-side contact 4. The unit-side contact 4 is fitted to the unit frame 2. The unit-side contact 4 is electrically connected to the development unit 1 mounted on the unit frame 2. In other words, removing the development unit 1 from the unit frame 2 breaks the electric connection between the development unit 1 and the unit-side contact 4.

The unit-side contact 4 is a leaf spring formed by bending a metal plate. The unit-side contact 4 is disposed on an end face of an outer circumferential part of the frame back portion 23 as seen from direction X. The unit-side contact 4 produces an urging force in a circumferential direction about the axis Ax as seen from direction X. Note that the unit-side contact 4 integrally has a fitted part 40, that is fitted to the frame back portion 23. For example, fastening the fitted part 40 to the frame back portion 23 with a screw brings a state where the unit-side contact 4 is fitted to the unit frame 2.

In the development unit 1, the development roller 11 and the regulation blade 12 are each electrically connected to the unit-side contact 4. To electrically connect the development unit 1 to the unit-side contact 4, for example, compression coil springs 41 and 42 are used. The compression coil springs 41 and 42 are each held on the unit frame 2 so as to produce an urging force along direction X. The compression coil springs 41 and 42 each have one end part of it along direction X in contact with the unit-side contact 4 (e.g., the fitted part 40) to be electrically connected to the unit-side contact 4. Note that, in FIG. 12, to clearly show the positions where the compression coil springs 41 and 42 are in contact with the unit-side contact 4, the unit frame 2 is not illustrated.

Another end part of the compression coil spring 41 along direction X is close-wound so as not to compress along direction X. The other end part of the compression coil spring 41 along direction X is in contact with the development roller 11. For example, the unit frame 2 has a holding hole (no reference sign assigned) formed in it that extends along direction X, so that the compression coil spring 41 is disposed in it. The shaft 111 is positioned by being inserted in the holding hole in the unit frame 2. This brings the tip face of the shaft 111 along direction X into contact with the compression coil spring 41 so that via the compression coil spring 41 the development roller 11 and the unit-side contact 4 are electrically connected together.

Likewise, another end part of the compression coil spring 42 along direction X is close-wound so as not to compress along direction X. The other end part of the compression coil spring 42 along direction X is in contact with the blade holder 120. Thus, via the compression coil spring 42 the regulation blade 12 and the unit-side contact 4 are electrically connected together.

Moving the unit frame 2 about the axis Ax brings the unit-side contact 4 into contact with or away from the body-side contact 3. Specifically, as seen from direction X, the body-side contact 3 is disposed on the path along which the unit-side contact 4 moves when the unit frame 2 is moved about the axis Ax. The position along direction X at which the body-side contact 3 is disposed is the same as the position along direction X at which the unit-side contact 4 is disposed. Thus, as shown in FIGS. 7 and 8, moving the unit frame 2 about the axis Ax brings the unit-side contact 4 away from or close to the body-side contact 3.

With the unit frame 2 held in the mounting/removing position (see FIG. 8), the unit-side contact 4 is not in contact with the body-side contact 3. That is, simply mounting the development unit 1 on the unit frame 2 does not result in the body of the image forming apparatus 100 and the development unit 1 being electrically connected together. In addition, removing the development unit 1 from the unit frame 2 results in the body of the image forming apparatus 100 and the development unit 1 not being electrically connected together.

From the state where the unit frame 2 is held in the mounting/removing position, that is, from the state where the unit-side contact 4 and the body-side contact 3 are out of contact with each other, moving the unit frame 2 about the axis Ax in one direction (clockwise) brings the unit-side contact 4 and the body-side contact 3 into contact with each other as shown in FIG. 7. The position of the unit frame 2 with the unit-side contact 4 and the body-side contact 3 in contact with each other is the regular position. That is, moving the unit frame 2 about the axis Ax in one direction to bring it from the mounting/removing position to the regular position results in the unit-side contact 4 and the body-side contact 3 being in contact with each other.

From the state where the unit frame 2 is held in the regular position, that is, from the state where the unit-side contact 4 and the body-side contact 3 are in contact with each other, moving the unit frame 2 about the axis Ax in the other direction (counterclockwise) releases the unit-side contact 4 and the body-side contact 3 from contact with each other. That is, moving the unit frame 2 about the axis Ax in the other direction to bring it from the regular position to the mounting/removing position results in the unit-side contact 4 and the body-side contact 3 being out of contact with each other.

In the embodiment, moving the unit frame 2 about the axis Ax brings the unit-side contact 4 into contact with or away from the body-side contact 3. That is, simply moving the unit frame 2 about the axis Ax achieves the turning-on and -off of the electric connection of the unit frame 2 with the body of the image forming apparatus 100.

This eliminates, from an assembly process for the image forming apparatus 100, a process dedicated to electrically connecting the body of the image forming apparatus 100 to the unit frame 2. That is, it is then possible to eliminate a wiring process for electrically connecting the body of the image forming apparatus 100 and the unit frame 2 with a cable (which can be a harness and the like).

For example, in these days, image forming apparatuses 100 are often assembled by automated production using a robot and the like. A wiring process involving a cable that is difficult to keep in position, and the like is unsuitable for automated production.

By contrast, according to the embodiment, all that needs to be done is to move the unit frame 2 about the axis Ax and this is suitable for automated production. Electrically connecting the body of the image forming apparatus 100 to the unit frame 2 by automated production leads to increased efficiency of automated production. This helps reduce the assembly cost of the image forming apparatus 100.

In addition, with the above configuration, when the development unit 1 is removed from the unit frame 2, the unit frame 2 is held in the mounting/removing position, so that the body of the image forming apparatus 100 is not electrically connected to the development unit 1. This prevents the development unit 1 from being removed from the unit frame 2 with the body of the image forming apparatus 100 electrically connected to the development unit 1. Further, it is then easy to assemble the image forming apparatus 100, even with the development unit 1 mounted on the unit frame 2, in a state where the body of the image forming apparatus 100 and the development unit 1 are electrically disconnected from each other.

According to the embodiment, as seen from direction X, the unit frame 2 has, as a fitted position P1 (see FIG. 7) at which the unit-side contact 4 is fitted, a position on a line extending from the axis Ax along a first direction D1. In addition, as seen from direction X, the unit frame 2 has, as a pressed position P2 (see FIG. 7), a position on a line extending along a second direction D2 different from the first direction D1. The unit frame 2 has the pressed portion 20 at the pressed position P2. That is, the pressed position P2 is a position pressed by the pressing portion 200.

With this configuration, pressing the pressed portion 20 (i.e., the pressed position P2) of the unit frame 2 easily moves the unit frame 2 in one direction about the axis Ax. That is, pressing the pressed portion 20 of the unit frame 2 easily brings the unit-side contact 4 into contact with the body-side contact 3.

According to the embodiment, the unit-side contact 4 is configures as a leaf spring. The unit-side contact 4 as a leaf spring presses the body-side contact 3 while in contact with the body-side contact 3. This helps securely maintain the contact between the unit-side contact 4 and the body-side contact 3.

Here, according to the embodiment, as seen from direction X, the distance L1 along the first direction D1 from the axis Ax to the fitted position P1 is shorter than the distance L2 along the second direction D2 from the axis Ax to the pressed position P2. Thus, the moment that acts about the axis Ax as a rotation axis with the fitted position P1 as the point of application is smaller than the moment that acts about the axis Ax as a rotation axis with the pressed position P2 as the point of application. As a result, when the unit frame 2 is moved about the axis Ax in one direction to be brought to the regular position, it can be prevented from being hampered by an urging force produced by the unit-side contact 4 and the body-side contact 3 making contact with each other.

The embodiment disclosed herein should be understood to be in every aspect illustrative and not restrictive. The scope of the present disclosure is set forth in the appended claims, and not in the above description of the embodiment. The scope of the present invention encompasses any modifications within a scope equivalent in significance to the claims.

What is claimed is:

1. An image forming apparatus comprising:
a photosensitive drum;
a development unit disposed opposite the photosensitive drum and having a development roller rotatably supported, the development unit feeding toner from the development roller to an electrostatic latent image on the photosensitive drum to develop the electrostatic latent image into a toner image;
a unit frame on which the development unit is removably mounted and that is movable about an axis parallel to a rotation axis of the development roller, the unit frame, by moving in one direction about the axis, moving the development roller in a direction toward the photosensitive drum and, by moving in an other direction about the axis, moving the development roller in a direction away from the photosensitive drum;
a unit-side contact fitted to the unit frame, the unit-side contact being electrically connected to the development unit mounted on the unit frame; and
a body-side contact disposed at a position where the body-side contact can make contact with the unit-side contact,
wherein
from a state where the unit-side contact and the body-side contact are out of contact with each other, moving the unit frame in the one direction brings the unit-side contact and the body-side contact into contact with each other and, from a state where the unit-side contact and the body-side contact are in contact with each other, moving the unit frame in the other direction releases the unit-side contact and the body-side contact from contact with each other.

2. The image forming apparatus according to claim 1, wherein
as seen from an axial direction of the axis, the unit frame has, as a fitted position at which the unit-side contact is fitted, a position on a line extending from the axis along a first direction,
as seen from the axial direction of the axis, the unit frame has, as a pressed position, a position on a line extending from the axis along a second direction different from the first direction, and
pressing the pressed position moves the unit frame in the one direction to bring the unit-side contact and the body-side contact into contact with each other.

3. The image forming apparatus according to claim 2, wherein
a distance along the first direction from the axis to the fitted position is shorter than a distance along the second direction from the axis to the pressed position.

4. The image forming apparatus according to claim 3, wherein
the unit-side contact is a leaf spring and presses the body-side contact while in contact with the body-side contact.
